(19) United States
(12) Patent Application Publication
(10) Pub. No.: US 2007/0178021 A1
(43) Pub. Date: Aug. 2, 2007

(54) Method and Apparatus for Generating Gaseous Chlorine Dioxide-Chlorine Mixtures

(75) Inventors: Thomas E. McWhorter, Allentown, PA (US); Aaron A. Rosenblatt, New York, NY (US); David Rosenblatt, Baltimore, MD (US); Barzin Keramati, Bethlehem, PA (US)

Correspondence Address: DESIGN IP, P.C., 5100 W. TILGHMAN STREET, SUITE 205, ALLENTOWN, PA, 18104, US

(73) Assignee: CDG RESEARCH CORPORATION, Allentown, PA (US)

(21) Appl. No.: 11/733,882

(22) Filed: Apr. 11, 2007

Related U.S. Application Data
(62) Division of application No. 10/051,995, filed on Jan. 18, 2002, now abandoned.

(51) Int. Cl. B01J 19/00; B01J 7/00

(52) U.S. Cl. 422/129

(57) ABSTRACT

Gaseous mixture of chlorine dioxide and chlorine produced by reacting an inorganic acid with an aqueous solution of an alkali metal chlorate by controlled introduction of the inorganic acid into the aqueous solution of alkali metal chlorate. Inorganic acid passed through a volume of alkali metal chlorate flowing through a horizontal reactor in a plug flow regime results in an enhanced gaseous mixture of chlorine dioxide, chlorine and steam that can be withdrawn as a product stream.

### CROSS REFERENCE TO RELATED APPLICATION(S)

This application is a division of U.S. patent application Ser. No. 10/051,995, filed Jan. 18, 2002, which is incorporated herein by reference as if fully set forth.

### BACKGROUND OF THE INVENTION

Chlorine dioxide is gaining increased acceptance as an alternative to chlorine for the disinfection of drinking water and for oxidation of contaminants in drinking water. Chlorine dioxide has a number of advantages over chlorine. Most specifically, chlorine dioxide:
1. Does not produce significant quantities of toxic chlorinated organic compounds such as trihalomethanes (THM's) when it reacts with organic materials in the water. These toxic compounds, which are produced by chlorination, are increasingly being associated with a variety of health problems;
2. Inactivates pathogens such a Cryptosporidium and Giardia which are not effectively inactivated by chlorine;
3. Is more effective than chlorine in oxidizing dissolved metals such as manganese to the insoluble state where they can be mechanically removed from the water;
4. Is more effective than chlorine in removing certain colors, tastes, and odors from the water; and
5. Is more effective than chlorine in controlling zebra mussels.

Chlorine dioxide is not widely used in treatment of waste water because it is more expensive than chlorine, and many of the compelling reasons for using chlorine dioxide in drinking water are less of an issue in waste water. Nevertheless, if the cost of chlorine dioxide could be sufficiently reduced, it might find widespread use in treatment of wastewater and in many other applications.

Chlorine dioxide is an unstable compound. It cannot be stored for extended periods of time. It cannot be effectively transported or piped over significant distances. It must be produced at the point of use. At high partial pressures and/or high temperatures, chlorine dioxide can undergo spontaneous and explosive decomposition. A key element in the design of chlorine dioxide systems is the assurance that conditions leading to explosive decomposition are avoided and/or that the system is designed to contain or safely vent any explosion.

Chlorine dioxide for drinking water treatment in the United States is usually produced by reacting sodium chlorite with chlorine either in aqueous solution such as disclosed in U.S. Pat. No. 4,590,057, or in a gas/solid reaction such as disclosed in U.S. Pat. No. 5,110,580, the specification of which is incorporated herein by reference. These generators, especially those based on gas/solid reaction technology, have resolved most of the issues that have previously slowed the widespread adoption of chlorine dioxide for water treatment as set out in the chapter 12 titled Chlorine Dioxide in the 4^{th} Edition of the Handbook Of Chlorination And Alternative Disinfectants, George Clifford White Consulting Engineer, John Wiley & Sons Inc., N.Y. 1999. Some chlorine dioxide generators combine sodium chlorite, acid, and sodium hypochlorite as disclosed in U.S. Pat. No. 4,247,531. These generators suffer from many of the problems associated with the use of sodium hypochlorite (as discussed below), but they avoid the problems associated with transport and storage of liquefied chlorine gas. Some older generators used in drinking water treatment react a solution of acid with a solution of sodium chlorite to produce chlorine dioxide as set out in the handbook referred to above. This process is inherently less efficient than the chlorine/sodium chlorite reaction and can introduce unwanted byproducts into the drinking water being treated.

Three primary issues remain for drinking water plants that are considering the use of chlorine dioxide:
1. Chlorine dioxide produced from sodium chlorite is expensive relative to the chlorine that it frequently replaces. Chlorine dioxide is often less expensive than the other alternatives to chlorine in situations where utilities must eliminate the use of chlorine to lower the levels of chlorinated organics in the drinking water. Nevertheless, the cost of chlorine dioxide produced from sodium chlorite has slowed its rate of acceptance.
2. Chlorine dioxide produced in most chlorine/chlorite generators—including the state-of-the-art gas/solid generators—requires the use of chlorine gas. Chlorine gas is becoming difficult or impossible to use in an increasing number of locations because of concerns over safety of, and regulations restricting use of, chlorine gas. Safety issues in the use of chlorine gas derive primarily from the possibility of accidental release of large volumes of gas from liquefied chlorine during transport and storage.

Many utilities are switching from gaseous chlorine to an aqueous solution of sodium hypochlorite (NaOCl) for disinfection. Sodium hypochlorite, when mixed with water, produces (depending on the pH) OCl⁻ or HOCl⁻ ions which are the same species produced when chlorine gas is added to water. Sodium hypochlorite, however, has several major disadvantages compared to chlorine. Sodium hypochlorite cannot be practically produced and stored in concentrations greater than 12%. This means that shipping costs are high. Aqueous solutions of sodium hypochlorite degrade over time, especially in hot weather. This causes product loss and necessitates regular analysis of the product to assure adequate disinfection. Sodium hypochlorite may also contain the bromate ion as a contaminant. Bromate ion is a closely regulated human carcinogen. Even if the bromate levels in the drinking water resulting from sodium hypochlorite use are below the regulated limits, they may combine with bromate from other sources to exceed the regulatory limits.
3. As it reacts with contaminants in the water, chlorine dioxide decays rapidly relative to certain other oxidizing chlorine species, such as chlorine and monochloramine. Therefore, ClO₂ is not generally used as a post-treatment oxidant for maintenance of a disinfectant residual in water distribution systems. Rather, chlorine and monochloramines are most often used for such purpose. Hence, most utilities that require ClO₂ also require Cl₂ or monochloramine.

In the pulp bleaching industry, chlorine dioxide is produced on a scale much larger than that usually used for drinking water. In the pulp industry, chlorine dioxide is usually produced by treating sodium chlorate with an acid (typically HCl or H₂SO₄) and/or with reducing agents such as hydrogen peroxide or methanol. Because sodium chlorate is much less expensive than sodium chlorite, the cost of chlorine dioxide produced in the pulp industry is much less than that of the chlorine dioxide produced for drinking water treatment.

Heretofore, the techniques used to produce chlorine dioxide for pulp bleaching have been viewed as inappropriate for drinking water (see Chapter 12 of Handbook of Chlorination And Alternative Disinfectants) because:
1. The generators used in pulp bleaching are complex. As a result, their capital cost is very high and they require highly skilled personnel for operation and maintenance.
2. They suffer from safety problems that are viewed as acceptable in a pulp mill, but not in a drinking water plant. For example, they are subject to mild explosions at relatively frequent intervals. In pulp plants, these “puffs” are vented safely, but the resulting release of gas and noise is not acceptable in a drinking water plant.
3. If the generators are not operated correctly, the drinking water treatment processes forms organic products containing substantial amounts of chlorine. Since many of the chlorine dioxide applications in drinking water are driven by the need to eliminate chlorine, a mixed chlorine/chlorine dioxide product has generally been viewed as problematic.
4. Many of these generation systems use reagents, or employ reaction chemistry, that can contribute impurities acceptable in pulp bleaching, but undesirable or unacceptable in potable water. These include chlorate ion, perchlorate ion and organic compounds (e.g. from methanol reactions).

Attempts have been made to adapt large-scale, chlorate-based, chlorine dioxide generator technology to drinking water treatment. These suffer from safety and toxicity concerns enumerated above.

Co-pending U.S. patent application Ser. No. 09/801,507 filed Mar. 8, 2001, the specification of which is incorporated herein by reference, describes techniques for the beneficial use of a mixture of chlorine and chlorine dioxide for oxidation and disinfection of drinking water without creating high levels of chlorinated organic compounds. This technology enables the use of mixed chlorine/chlorine dioxide products from a generator with metal chlorate and acid as feed. One important aspect of this patent application is the use of ammonia to convert chlorine to monochloramine. Monochloramine is gaining increasing acceptance in the water industry as a residual disinfectant in the water distribution system.

There are numerous technologies for producing chlorine/chlorine dioxide mixtures by reacting alkali metal chlorates (typically sodium chlorate) with acids. These processes are described in Ullman's Encyclopedia of Industrial Chemistry as well as numerous other references.

Hydrochloric acid and sodium chlorate participate in two competing reactions:
2NaClO₃+4HCl->2ClO₂+Cl₂+2NaCl+2H₂O Reaction 1
and
NaClO₃+6HCl->3Cl₂+NaCl+3H₂O Reaction 2

Because both of these reactions produce chlorine, the product of this process is a mixture of chlorine and chlorine dioxide. In a pulp mill, the two gases are separated in a stripper. Chlorine dioxide is used for bleaching; chlorine, which is considered undesirable, is recycled to the process.

Reaction 1, which produces chlorine dioxide, is favored by low ratios of chloride ion to chlorate ion. As reactions 1 and 2 progress, chloride ions build up in the solution and reaction 2 (which does not produce chlorine dioxide) is increasingly favored. Therefore, the generation process is usually stopped long before completion. The process is operated so that when sodium chlorate begins to be depleted, and sodium chloride begins to build up, the reacting solution is recycled through an electrolytic cell to convert chloride to chlorate ion. A by-product of this electrolysis is hydrogen. The hydrogen from the electrolytic cell is burned with fresh chlorine and recycled chlorine to produce hydrochloric acid which is returned to the process. Such techniques are used in the well-known Day-Kesting Process for producing chlorine dioxide.

A plant utilizing the Day-Kesting process is efficient in terms of chlorine dioxide yield, but it is expensive in terms of capital cost. It is very complex and requires high levels of maintenance.

Canadian Patent 1 1954 77 describes a process (referred to as R5/R6 process) for high efficiency production of chlorine dioxide, wherein a concentrated solution of sodium chlorate and a concentrated solution of hydrochloric acid are continuously added to a reactor. Sodium chloride is continuously crystallized in the reactor and removed as a solid from the reactor. The ratio of chloride to chlorate ions in the reactor is maintained at a very low level because the combination of chloride and chlorate reaches a composition wherein high concentrations of chlorate ions greatly lower the solubility of chloride salts. This process is reported to achieve very high ratios of chlorine dioxide to chlorine in its products. For use in the water treatment industry, this process suffers from two drawbacks, namely:
a) Efficient implementation of this process requires filtering and washing the salt removed from the reactor to remove sodium chlorate and returning the sodium chlorate to the reactor. Equipment for this filtering and washing is expensive and suffers from high maintenance requirements inherent to a mechanical apparatus in an abrasive and corrosive environment; and
b) The water industry often requires higher chlorine/chlorine dioxide ratios than the R5/R6 process produces. Therefore, in many applications, (and contrary to the practice in the pulp industry) a less efficient generator, i.e. one that produces a lower chlorine dioxide/chlorine ratio, is often desirable.

Another process (referred to as the R2 process) also proceeds according to two competing reactions.
2NaClO₃+2NaCl+2H₂SO₄→2ClO₂+Cl₂+2Na₂SO₄+2H₂O Reaction 1
NaClO₃+5NaCl+3H₂SO₄→3Cl₂+3Na₂SO₄+3H₂O Reaction 2

Typically this process is carried out with a high excess of (sulfuric) acid to maximize reaction 1, and produces a sodium sulfate “waste” stream. In a pulp mill the excess acid can be regenerated, and the sodium sulfate can be integrated into the chemical recovery system. In a drinking water plant, this recovery would be extremely problematic and “chemical recovery” of sodium sulfate would be pointless.
3. Other processes use reducing agents such as SO₂, and methanol to drive the sodium chlorate/sulfuric acid reaction to produce high concentrations of chlorine dioxide with relatively little chlorine. However, methanol is a toxic, volatile organic chemical which would not be acceptable in a drinking water plant; and SO₂ is a hazardous liquefied gas which has many of the same hazards as liquefied chlorine.

Another process reacts sodium chlorate with sulfuric acid and hydrogen peroxide. This technology has been tried in drinking water applications, but suffered from safety issues and from concern about the potential to produce high levels of perchlorate ions under certain upset conditions. Also, because oxygen is evolved in this reaction it inherently produces as its product a “foam” which may contain (non-gaseous) un-reacted chlorate ion, as well as other unwanted ionic species, and a very substantial excess of acid, which can upset pH conditions in many waters.

Another proposed process uses an aqueous chlorate solution with gaseous anhydrous hydrochloric acid to produce chlorine dioxide for drinking water treatment as described in U.S. Pat. No. 5,204,081. Based upon Patentees data and the disclosure of the Patent, this process produces a chlorine/chlorine dioxide ratio of 0.85. This process suffers from two primary drawbacks:
1. It uses anhydrous gaseous hydrochloric acid as one of its reagents. One of the primary objectives of the present invention is to eliminate the storage and transport of dangerous volatile reagents such as liquefied chlorine gas. Anhydrous hydrochloric acid (HCl), like liquefied chlorine, can spread its toxic vapors across large populated areas if the transport or storage vessels are compromised by accident, sabotage, or terrorist actions.
2. The products and any aqueous phase by-products or unreacted reagents are drawn directly into the drinking water. If the reagents contain any impurities, these are carried into the drinking water. If the ratio of the reagents is not precisely adjusted, unreacted acid, unreacted chlorate, or by-products of incomplete reaction are also carried into the drinking water.

Many water treatment plants have highly variable production rates. Seasonal fluctuations in production are almost universal, and diurnal production fluctuations are common. Although to some extent, fluctuations are reduced by storage and release of finished water, fluctuations of 200% over the period of a day are not uncommon. In some cases production fluctuations are even larger, and may occur rapidly. It is therefore important that a chlorine dioxide generator intended for water treatment be capable of turndown over a wide range without readjustment or loss of efficiency.

The drinking water industry is especially sensitive to contaminants and by-products that may be introduced into the water. Some chlorine dioxide generators carry out the reaction that produces chlorine dioxide in the solution phase wherein some or all of the solution enters the treated water along with the chlorine dioxide product. This introduces the possibility that undesirable or dangerous reaction by-products (e.g. perchlorate ions), or unreacted reagents (e.g. chlorite or chlorate ions) may be added to the drinking water. Since none of these undesirable ionic species exists in the gas phase, it is advantageous that products of the chlorine dioxide generator be gaseous.

Thus there is a need to provide a safe cost-effective process for producing water disinfectant/oxidation reactants.

### SUMMARY OF THE INVENTION

A primary goal of this invention is a relatively simple, controllable system that can safely co-produce chlorine dioxide and chlorine (or sodium hypochlorite or monochloramine) at lower cost than chlorite-based systems and without the need to transport and store large volumes of liquefied chlorine.

The present invention is a method and apparatus for generating a gaseous mixture of chlorine dioxide and chlorine especially for the treatment of drinking water or waste water. Chlorine and chlorine dioxide are produced by reacting, in a controlled manner, an inorganic acid with an alkali metal chlorate. The product mixture can be used as an oxidant and disinfectant for drinking water in accord with the teachings of co-pending U.S. patent application Ser. No. 09/801,507 filed Mar. 8, 2001, or it may be used in non-water applications.

Therefore, in one aspect the present invention is a method for producing a gaseous mixture of chlorine dioxide and chlorine comprising the steps of: establishing a volume of an aqueous solution of sodium chlorate at a temperature between 20° C. and 95° C.; introducing hydrochloric acid at several locations within the volume of the aqueous solution of sodium chlorate, the hydrochloric acid having a temperature between 20° C. and 95° C., permitting the hydrochloric acid to react with the aqueous solution of sodium chlorate, causing bubbles of chlorine dioxide, chlorine and water to rise through the aqueous solution of sodium chlorate, collecting gaseous chlorine dioxide, chlorine and steam in a head space maintained over the volume of the aqueous solution of sodium chlorate; and producing a product stream by dissolving the gaseous chlorine dioxide, the chlorine, and the steam in water.

In another aspect, the present invention is a method for producing a mixture of chlorine and chlorine dioxide comprising the steps of: introducing an aqueous solution of an alkali metal chlorate with an inorganic acid into a reactor and permitting at least 90% by weight of the alkali metal chlorate to react with the inorganic acid to produce gaseous chlorine, chlorine dioxide and steam in a gas head space of the reactor; removing the gaseous chlorine, chlorine dioxide and steam in water to produce a product stream.

In yet another aspect the present invention is a reactor for generating a gaseous mixture of chlorine dioxide, chlorine and water by reacting an aqueous solution of an alkali metal chlorate and an inorganic acid comprising: a first horizontally disposed reactor section having a first end adapted to introduce the alkali metal chlorate and inorganic acid into the reactor section, a second end of the reactor section having means to impound a volume of the aqueous solution of an alkali metal chlorate within the reactor with a gas space above the volume of the aqueous solution of an alkali metal chlorate; means to introduce the inorganic acid at a plurality of locations along at least a portion of the length of the volume of the aqueous solution of an alkali metal chlorate; means to withdraw gaseous reactant products from the gas space; and collection means at the second end of the reactor section to collect waste liquor from the reactor section.

### BRIEF DESCRIPTION OF THE DRAWINGS

FIG. 1 is a longitudinal section of a reactor according to the invention.

FIG. 2 is a schematic representation of a plurality of reactors of FIG. 1 used to implement a method of the invention.

FIG. 3 is a plot of production rate against time for a staged reactor according to the invention.

FIG. 4 is a schematic representation of an experimental apparatus used to simulate an embodiment of the present invention.

FIG. 5 is a plot of efficiency of chlorine dioxide production against the ratio of chloride ion concentration to chlorate ion concentration.

FIG. 6 is a schematic representation of the apparatus of FIG. 1 illustrating recycling of a brine solution to the reactor.

FIG. 7 is a schematic representation of an alternate embodiment of the present invention.

FIG. 8 is a schematic representation of an embodiment of the present invention illustrating a water saving feature.

FIG. 9 is a schematic representation of the embodiment of FIG. 8 illustrating an alternate method of controlling gas space in the product storage tank.

### DETAILED DESCRIPTION OF THE INVENTION

Because the objective of chlorine dioxide generators in the pulp industry is to produce only chlorine dioxide, in the most efficient way possible, with as little chlorine as possible, competing reactions that produce chlorine are viewed as wasteful. (“Progress” in R&D of pulp mill generators has moved, over time, toward higher and higher ClO₂ productions, and minimal production of Cl₂, an unwanted contaminant.) The generators are therefore designed to operate in a way to maximize production of chlorine dioxide and minimize competing reactions. The overall process is typically operated with concentrations of reagents and at temperatures and pressures that favor the reactions that produce chlorine dioxide. Reagents that are not consumed in this range of operation are typically recycled in elaborate and expensive recycling processes.

One goal of the process and apparatus of the present invention is produce both chlorine and chlorine dioxide, and to optimize the production of the combined product stream to fit the needs of the user in non-pulp and paper applications, especially water treatment. Another goal of the process and apparatus of the present invention is to minimize the production of problematic waste materials such as highly acidic streams, sodium sulfate, or waste streams containing substantial amounts of unreacted chlorate ions.

These goals are achieved by mixing the reagents in approximately stoichiometric ratios to complete both the reaction that favors production of chlorine dioxide and the competing reaction that produces chlorine but no chlorine dioxide. One innovative aspect of the current invention is to run the reaction over its entire range, all the way to completion, with the intent of producing both chlorine and chlorine dioxide. The ratio of chlorine to chlorine dioxide can be controlled over a wide range through various techniques disclosed herein. In one preferred embodiment of this invention, the minimum chlorine/chlorine dioxide ratio that could be achieved was about 2.00. In an alternate preferred embodiment of the invention the maximum chlorine to chlorine dioxide ration that can be achieved is approximately 7.0. In both preferred embodiments, the reagents are added in approximately stoichiometric ratios and the reactions proceed approximately to completion.

In generators designed for the pulp industry, the reaction is carried out over a fairly narrow range of reagent concentrations, and intentionally terminated prior to completion. This is achieved, for example, in a stirred reactor where reagents are continuously added and products are continuously removed at constant concentrations. These reactors are typically vertical vessels (e.g. U.S. Pat. No. 5,458,858). In some embodiments the flow of reacting solution is horizontal (e.g. U.S. Pat. No. 4,851,198) in a circular or spiral pattern. In these reactors, gas is constantly evolving in the liquid as chlorine, chlorine dioxide, and steam. In a vertical vessel, with flow from top to bottom or bottom to top, the evolving bubbles create turbulent mixing. These reactors are therefore back-mixed as opposed to plug flow reactors. As a result, the reaction is never complete as the reacting solution flows from one vessel to another. This necessitates either very large vessels where the final reaction can approach completion (U.S. Pat. No. 3,502,443) or a large number of vessels or chambers. If the production rate of the reactor must be changed in a stirred reactor, the ratio of chlorine/chlorine dioxide will also change. In a pulp mill, the production rate is intentionally held relatively constant, and the unwanted chlorine contaminant is separated from the desired chlorine dioxide product. In the present invention, the ability to control the chlorine/chlorine dioxide ratio over a wide range of turndown and production rates are key goals.

A plug flow reactor is a reactor in which the concentration of reagents is constant across a plane which is a cross section of the reactor and which is perpendicular to the flow of the reacting solution. The concentration of the reagents and products varies over the length of the reactor.

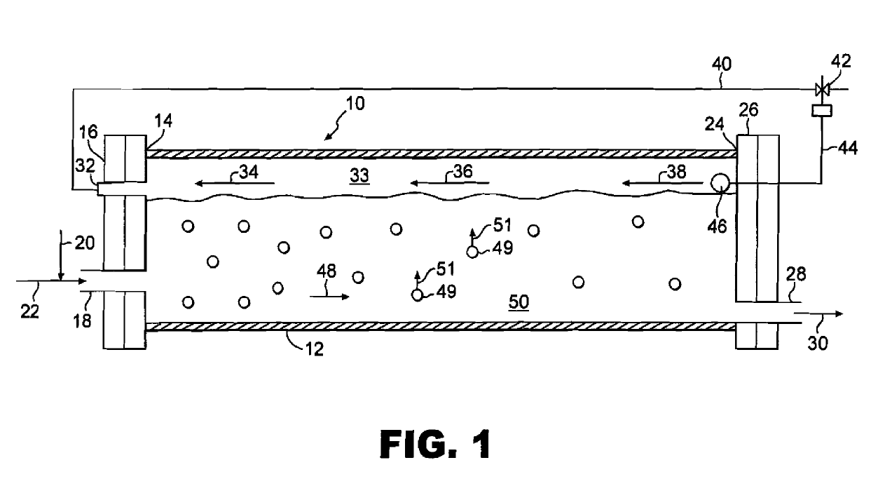

Referring to FIG. 1, a basic reactor 10 according to the present invention has a horizontal chamber 12 and a first end 14 closed by a flange 16. Flange 16 contains an inlet conduit 18 to admit reactants consisting of an inorganic acid shown by arrow 20 and an alkali metal chlorate shown by arrow 22. Second end 24 of horizontal chamber or cylinder 12 is closed by a similar flange 26 which contains an outlet conduit 28 so that liquid can move out of the reactor 10 as shown by arrow 30. Reactor 10 includes an outlet conduit 32 in flange 16 communicating with a head or gas space 33 in horizontal chamber 12 so that gaseous reaction products shown by arrows 34, 36 and 38 can be removed from head space 33 of reactor 10 via the outlet conduit 32 and a collection conduit 40. Collection conduit 40 contains a control valve 42, which is connected via suitable connections, as are well known in the art, to a level control device 46 within reactor 10 as will be more fully explained hereinafter.

Reactor 10 is disposed horizontally so that reactants introduced through inlet conduit 18 flow substantially in a plug flow through the reactor 10 in a direction shown by arrow 48. As the reactants flow through the reactor 10, bubbles of gas, generated by the reaction of the inorganic acid and the alkali metal chlorate, being gas phase products of chlorine, chlorine dioxide and steam, rise vertically through the liquid reactant solution bath 50 resulting in gaseous reactants being accumulated in head space 33 in reactor 10. The gaseous reactants shown by arrows 34, 36 and 38 consisting of chlorine, chlorine dioxide and steam are then removed by conduit 32 from reactor 10 for use as will hereinafter be more fully explained. Reactant bubbles 49 move in the direction shown by arrows 51 in FIG. 1.

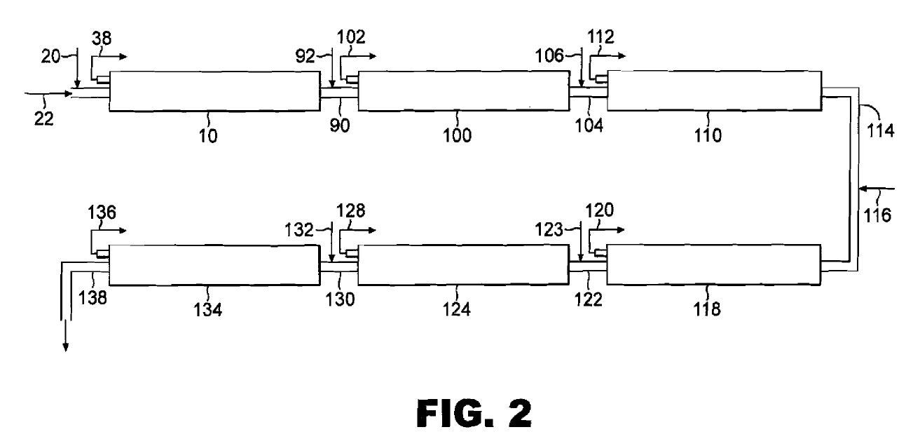

Referring to FIG. 2, a series of reactors 10, 100, 110, 118, 124 and 134, all similar in construction to the reactor shown in FIG. 1, are disposed horizontally in a series relationship. Reactor 10 receives the inorganic acid as shown by arrow 20 and the alkali metal chlorate shown by arrow 22, and product gases are withdrawn as shown by arrow 38. The liquid reactants from reactor 10 are conducted via conduit 90 to reactor 100 with additional inorganic acid shown as arrow 92 introduced into the liquid. A product consisting of a gaseous mixture of chlorine/chlorine dioxide/steam, shown by arrow 102 is withdrawn from reactor 100 and the liquid reactants in reactor 100 are conducted via conduit 104 to reactor 110 with additional inorganic acid being added to conduit 104 as shown by arrow 106. The gaseous product stream 102 from reactor 100 has a higher chlorine/chlorine dioxide ratio than the chlorine/chlorine dioxide ratio in product stream 38. Reactor 110 receives the liquid reactants from reactor 100 and produces a product as shown by arrow 112, which is similar to product stream 102 except for a higher chlorine/chlorine dioxide ratio. The reactants from reactor 110 are conducted by conduit 114, with the addition of inorganic acid shown by arrow 116, to reactor 118 which produces a product stream 120 identical in composition to product streams 38, 102 and 112, but with a higher chlorine/chlorine dioxide ratio than in stream 112. Liquid reactants from reactor 118 are conducted via conduit 122, with the addition of inorganic acid shown by arrow 123, to reactor 124, which produces a product stream 128 identical in composition to product stream 120, except for a higher chlorine/chlorine dioxide ratio. Liquid from reactor 124 is conducted via conduit 130, with the addition of additional inorganic acid shown by arrow 132, to reactor 134 where a product stream 136 similar in composition to product stream 128 is produced, but with a higher chlorine/chlorine dioxide ratio. Lastly, the remaining liquid reactants are removed from reactor 134 via conduit 138 and disposed of in accordance with governmental regulations or reused to recover the reactants. All the reactors shown in FIG. 2 are substantially identical and are disposed horizontally to achieve plug flow of liquid reactants through each reactor. Each of the reactors of FIG. 2 is fitted with a level control so that a gaseous head space is maintained in each reactor to receive product.

In a preferred embodiment of the invention (FIGS. 1 and 2), the reacting solution flows through a series of horizontal reactors. As the solution flows, bubbles of gaseous products rise in a direction perpendicular to the flow of the solution. The rising bubbles produce mixing perpendicular to the flowing stream, but not forward or backward in the flowing stream. At the top of the horizontally oriented reactors, a gas space is maintained by a level control device such as a level control valve. Gaseous products flow in this gas space parallel to the flow of the liquid solution. This flow may be either co-current or counter-current to the flow of the liquid. However, counter current flow may be preferred for reasons as disclosed herein. Gaseous products are removed preferably from the first or entry end of each reactor.

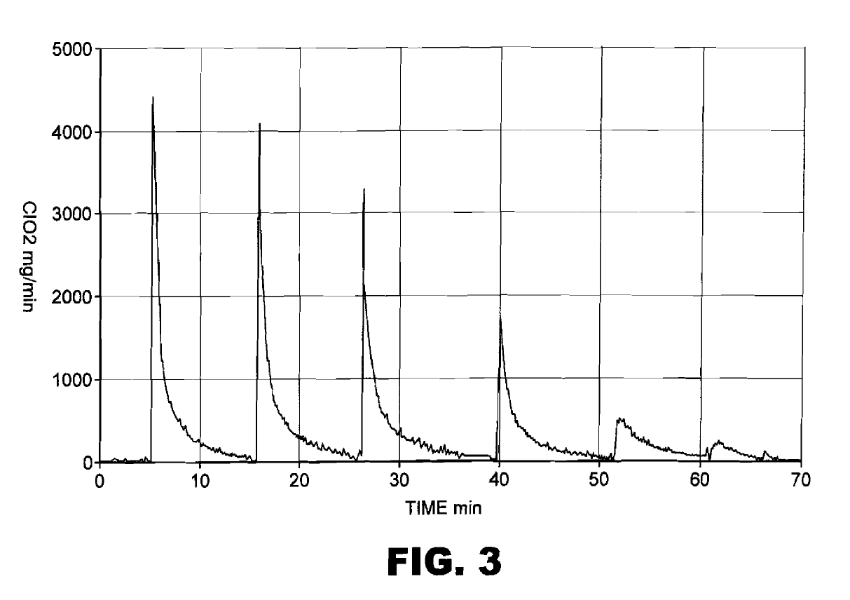

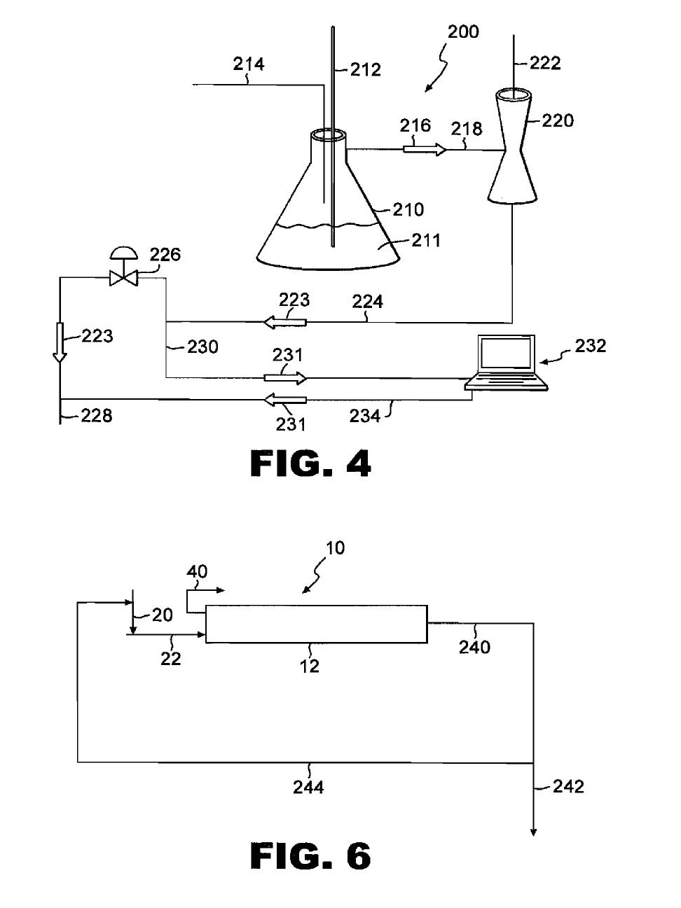

Operation in a plug-flow mode allows each stage of the reaction to approach completion before the solution enters the following stage. In the present invention, the reactors are sized so that, at the maximum production rate, the reaction is essentially complete when the solution exits each stage of the process. FIG. 3 shows the production rate of chlorine dioxide over the length of each stage of the generator. The data for FIG. 3 was generated using the experimental set-up shown in FIG. 4, which simulated a continuous plug flow reactor.

Referring to FIG. 4 the experimental setup 200 included a reactor flask 210 into which was introduced an aqueous solution of sodium chlorate 211 with a concentration of approximately 400 grams per liter. An inorganic acid, e.g. hydrochloric acid, was introduced into conduit or tube 212 to react with the sodium chlorate solution 211. Air at approximately 0.3 standard cubic feet per minute was introduced into the reactor 210 via conduit 214. The reactor 210 was maintained at a temperature of 80° C. under a slight vacuum. Reaction products represented by arrow 216 were withdrawn from the top of the reactor 210 and conducted via conduit 218 to an ejector 220 where water flowing at approximately 6 gallons per minute was introduced into the injector via conduit 222. The reaction products dissolved in the water represented by arrow 223 were conducted via conduit 224 through a back pressure valve 226 set at 2.5 psi to a suitable drain conduit 228. Samples represented by arrow 231 withdrawn via conduit 230 were analyzed in a data acquisition system shown generally as 232. The data acquisition/analysis system 232 consisted of a UV spectrophotometer with data logging capability. Samples 231 after analysis were conducted via conduit 234 to the drain 228. With a known flow of water through conduit 222, and a measured concentration of chlorine dioxide in said flow of water, the production rate of chlorine dioxide could be calculated. FIG. 3 is a plot of this production rate vs. time for one experiment.

Set forth in Table 1 are data taken from two runs utilizing the experimental setup of FIG. 4, simulating a multistage reactor as shown in FIG. 2.

TABLE 1

| | RUN #1 | RUN #2 |
|---|---|---|
| Reactor Temperature (° C.) | 80 | 80 |
| Water Flow Rate (L/min) | 25.60 | 25.30 |
| Air Flow Rate (SCFM) | 0.27 | 0.26 |
| Reactor Vacuum (in Hg) | −1 | −1 |
| Sample Pressure (PSI) | 2.5 | 2.5 |
| Time (Total Run) (MIN) | 70 | 50 |
| Sample Interval (SEC) | 6 | 6 |
| NaClO₃ Solution Volume (ml) | 125 | 125 |
| NaClO₃ Concentration g/l | 400 | 400 |
| HCl Volume (ml) | 270 | 270 |
| HCl Concentrate | 220 | 220 |
| # of HCl Injections | 6 | 4 |
| ClO₂ Production (mg) | 20,624 | 20,159 |
| Cl₂ Production (mg) | 45,780 | 47,005 |

Measurement of chlorine gas in chlorine dioxide is difficult because the two species absorb in the same frequency ranges in a spectrophotometer. Therefore, the gaseous products were dissolved in flowing water which was analyzed in a spectrophotometer. In aqueous solution chlorine forms OC¹—, HCl, and HOCl, which do not absorb in the same frequency range as chlorine dioxide. In aqueous solution, chlorine dioxide exists as a dissolved gas that can be measured readily by a UV spectrophotometer. The production of Cl₂ in many of the examples given herein was calculated by mass balance assuming that the sodium chlorate or the HCl (whichever was the limiting reagent) was totally consumed in the two reactions set out below. The validity of this assumption was tested several times by collecting the water from an entire test run and measuring the chlorine by titration.

The foregoing data illustrate a method according to the invention to produce chlorine dioxide utilizing the reaction of an inorganic acid, e.g. hydrochloric acid, with an alkali metal chlorate solution (aqueous solution of sodium chlorate).

As the solution flows from one reactor to the next, the concentration of chlorate ions is depleted and the concentration of chloride ions increases. This causes more and more of the reaction to occur as Reaction 2 and less and less as Reaction 1 set out below:
2NaClO₃+4HCl→2ClO₂+Cl₂+2NaCl+2H₂O Reaction 1
2NaCl0₃+6HCl→3Cl₂+NaCl+3H2O Reaction 2

As the liquid solution flows down the length of the plug flow reactor, the concentration of reagents continues to change until one of the reagents is essentially totally consumed, and no further reaction occurs. If the length of the reactor is sufficient, the liquid continues to flow beyond the point where the reaction is completed. If the process is designed so that the ratio of the raw materials (e.g. HCl/chlorate solution) injected into each section is constant and the production rate is controlled by the rate at which reagents are added to the reactor in this proportion, then the ratio of products (chlorine/chlorine dioxide) produced in that reactor segment will be constant so long as the reactor is sized so that the reaction is essentially complete before the reacting solution exits the reactor.

The embodiment of the invention, as sown in FIGS. 1 and 2, is a multi-stage plug flow reactor consisting of a long horizontal reactor or several horizontal reactors connected in series wherein the primary (“motive”) reagent (i.e. chlorate solution) flows through all of the reactors or reactor segments in series and the secondary reagent (i.e. acid) is injected in increments over the length of the flow of primary reagent. If the rate of injection of the secondary reagent at each injection point is always maintained at a constant ratio to the rate of flow of the primary reagent, and if the reactor vessel(s) are sized so that, at the maximum production rate, the reaction is essentially complete in each vessel before the reagent solution exits that stage, then the production can be turned down from the maximum rate without substantially changing the ratio of the production rate of the products.

One way to achieve this is to feed the reagents to the various injection points using a number of positive displacement pumps such that all of the pumps are turning at the same speed. For example, this could be achieved with a multi-head peristaltic pump with the primary reagent solution pumped by one head and each of the flows of secondary reagent pumped by one other head. If all of the pump heads are mounted on the same shaft, the ratio of each flow to all others will always be constant. Overall rate of flow can be controlled simply, by controlling the speed at which the common shaft turns.

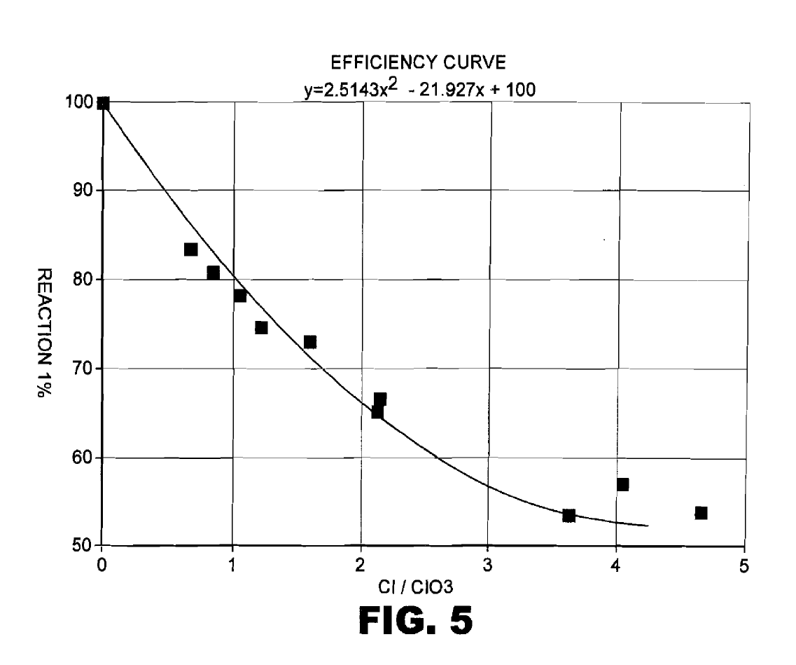

In many situations, a higher ratio of chlorine to chlorine dioxide may be desirable. Since different applications and different water chemistries demand different ratios of chlorine to chlorine dioxide, it is important to be able to adjust the ratio of these gases. This can be achieved in 2 ways.
1) In all acid/chlorate processes that produce chlorine, the ratio of reaction 1 (which produces chlorine dioxide) to reaction 2 (which produces only chlorine) is determined by the relative proportion of the reagents and the solution-phase products. For example in the HCl/chlorate process, the fraction of total chlorate that is consumed in reaction 1 is a function of the ratio of the chloride ion to the chlorate ion in solution. Studies targeting the pulp industry have shown this relationship for low chloride/chlorate ratios where reaction 1 is strongly favored. FIG. 5 shows this relationship over the entire range of the reactions. One aspect of the invention is to intentionally add chloride ions above the levels that are produced in the reaction in order to increase the ratio of chlorine to chlorine dioxide. This chloride ion may be added at various points in the process stream to achieve different ratios of chlorine/chlorine dioxide. Another innovation is to use a portion of the waste brine from the process as a source of the chloride ion as shown in FIG. 6. Referring to FIG. 6 a portion of the final liquid stream 240 taken from reactor 10, or the last reactor in a staged reactor scheme as described above in relation to FIG. 2, containing brine (NaCl+H₂O) is recycled to reactor 10 via conduit 244 instead of being sent to a waste handling facility via conduit 242.
   Since dissolved sodium chlorate and dissolved sodium chloride form a eutectic, as is known in the art, the amount of chloride that can be added to the chlorate solution is limited. It may therefore be desirable to add chloride ions to the HCl solution, especially in conjunction with the practice described below wherein chlorate solution is added to a stream of HCl as opposed to the reverse.

Table 2 shows the effect of adding 150 g/l of sodium chloride to the sodium chlorate solution.

TABLE 2

| Parameter | Unit | Value | | | |
|---|---|---|---|---|---|
| Primary feed type | Text | HC1 into NaC10₃ | | NaC10₃ into HCI | |
| Reactor temperature | C. | 80 | 80 | 80 | 80 |
| Water flow rate | Lit/min | 25.5 | 24.5 | 24.6 | 24.9 |
| Air flow rate | SCFM | 0.26 | 0.23 | 0.23 | 0.23 |
| Reactor pressure | In Hg | −1 | −1 | −1 | −1 |
| Sampling pressure | Psig | 2.5 | 2.5 | 2.5 | 2.5 |
| Process time | Min | 15 | 15 | 11 | 10 |
| Sampling interval | Sec | 8 | 8 | 8 | 8 |
| NaClO₃ + NaCl volume | ml | 60 | 60 | 48 | 48 |
| NaClO₃ concentration | g/lit | 400 | 400 | 400 | 400 |
| NaCl concentration | g/lit | 0 | 150 | 0 | 150 |
| HCl volume | ml | 130 | 130 | 130 | 130 |
| HCl concentration | g/lit | 220 | 220 | 220 | 220 |
| ClO₂ produced | mg | 10400 | 9570 | 4100 | 3840 |
| Cl₂ produced | mg | 20660 | 22840 | 25680 | 25830 |
| Cl₂/ClO₂ production ratio | mg/mg | 1.99 | 2.39 | 6.26 | 6.73 |

2) Since hydrochloric acid is itself a source of chloride ions, the pattern of adding acid to the solution may be altered to increase chlorine production up to this limit. Chlorine dioxide generators for the pulp industry are designed to produce the maximum ratio of chlorine dioxide/chlorine. Therefore, they always add acid to a concentrated chlorate solution. The innovation is to increase the chlorine/chlorine dioxide ratio by adding higher doses of acid to the chlorate solution. For example, the pattern of HCl addition shown in FIG. 2 produces a chlorine/chlorine dioxide ratio of 2.25. On the other hand if the reactant stream 22 is an HCl/water solution and sodium chlorate is injected at 20, 42, 106, 116, 124 and 134 shown in FIG. 2, this produces a ration of 3.78. In this extreme case, small increments of chlorate solution are added to a stream of HCl (the reverse of the practice in the pulp industry generators).

FIG. 5 shows the efficiency of chlorine dioxide as a function of the ratio of chloride ion concentration to chlorate ion concentration at 80° C. In this case, efficiency is defined as the amount of chlorate consumed in reaction 1 compared to the total amount consumed in reaction 1 and 2. This relationship has been published for low chloride/chlorate, ratios, but the data have not been shown over the entire range of chloride/chlorate ratios.

Canadian Patent 1 195 477 describes operation of the HCl/sodium chlorate reaction at temperatures between 65° C. and 70° C. to maximize the production of chlorine dioxide in reaction 1 versus production of chlorine in reaction 2.

Table 3 shows the effect of lowering the temperature of the reaction to increase the production of chlorine over the production of chlorine dioxide.

TABLE 3

| | | |
|---|---|---|
| Parameter | Unit | Value |

| | | | |
|---|---|---|---|
| Feed type | Units | HCl | HCl |
| Reactor temperature | ° C. | 80 | 35 |
| Water flow rate | Lit/min | 25.56 | 18.59 |
| Air flow rate | SCFM | 0.26 | 0.13 |
| Reactor pressure | In. Hg | −1 | −1 |
| Sampling pressure | Psig | 2.5 | 2.5 |
| Process time | Min. | 15 | 61 |
| Sampling interval | Sec. | 8 | 8 |
| NaClO₃ + NaCl volume | Ml | 100 | 100 |
| NaClO₃ concentration | g/l | 600 | 600 |
| NaCl concentration | g/l | 0 | 0 |
| HCl volume | Ml | 330 | 330 |
| HCl concentration | g/l | 220 | 220 |
| ClO₂ produced | Mg | 25830 | 22520 |
| Cl₂ produced | Mg | 52090 | 60800 |
| Cl₂/ClO₂ production ratio | Mg/mg | 2.02 | 2.70 |

As the number of stages in a multi-stage reactor increase, the complexity and capital cost of the system increases. As the number of stages decreases below an optimum, however, both the flexibility of control and the ability to maximize chlorine dioxide efficiency when needed decreases. Therefore, in a preferred mode of this embodiment, the acid would be injected in 3-12 stages with 4-6 stages as the optimum.

It is well known that under certain conditions chlorine dioxide can decompose spontaneously with explosive force. It is well known that such explosions occur from time to time in the pulp industry. In most chlorine dioxide generators, the tendency to explode is controlled by controlling the partial pressure of the chlorine dioxide. In various processes, this is accomplished by a combination of dilution with other gases such as air, chlorine or steam and by operating the process under vacuum. In at least one process, the tendency to explosion is limited by removing the chlorine dioxide very rapidly from the chamber in which it is produced. All of these approaches to minimizing explosions have their limitations.

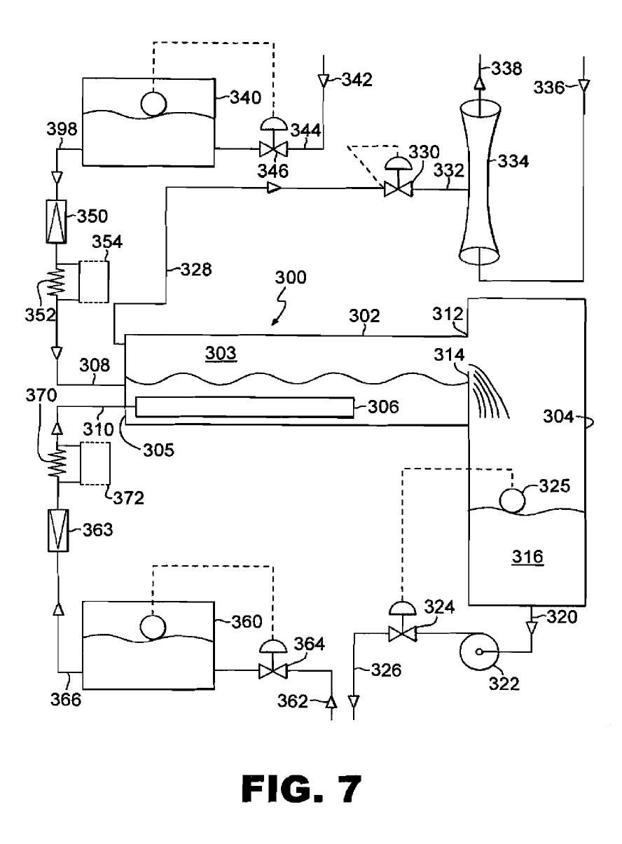

Referring to FIG. 7, there is shown another embodiment of the present invention that employs a single reactor 300 which contains a horizontal reactor portion 302 and a vertical waste receiving portion 304. Disposed in the bottom of the reactor portion 302 is a longitudinal diffuser 306. The first end 305 of reactor portion 302 contains inlet conduits 308 and 310 for introducing reactants into the reactor portion 302. Thus, as the sodium chlorate solution flows down the length of conduit 302, acid solution is added at a plurality of points over the length of diffuser 306. The second end 312 of reactor portion 302 contains an open passage which is partially blocked by a weir on dam 314, so that solution can flow over the weir 314 into a collection or waste receiving portion 304, where an inventory of waste liquor 316 can be collected and either recycled as shown in FIG. 6 or disposed of via conduit 320, pump 322, liquid level control valve 324, and a waste liquor line 326. The waste liquor in line 326 can be disposed of in accordance with federal and local regulations or be subjected to a reclamation of reactants for reuse in the process. Liquid level control valve 324 is connected to a suitable level indicator 325 as is well known in the art.

Reactor portion 302 contains a product removal conduit 328 which in turn is connected to a vacuum control valve 330 which in turn communicates via conduit 332 to an injector 334 so that water as represented by arrow 336 can be introduced into the injector to remove a mixture of water, chlorine dioxide and chlorine represented by arrow 338. An inventory of alkali metal chlorate e.g. NaClO₃ is maintained in a suitable vessel 340 which receives makeup, represented by arrow 342, from a solution tank (not shown) through conduit 344 and liquid level control valve 336. Alkali metal chlorate solution as needed is withdrawn from vessel 340 via conduit 398 and passes in sequence through a flow meter 350 temperature control coil 352 with associated temperature controller 354 and conduit 308 for introduction into reactor portion 302. In a like manner a solution of an inorganic acid is maintained in a storage vessel 360 which is connected to an inorganic acid storage vessel represented by arrow 362, the level of the inorganic acid in vessel 360 controlled by a liquid level control valve 364 as is well known in the art. Inorganic acid, e.g. HCl, is withdrawn by conduit 366 and passes through flow meter 368 temperature control device 370 with associated temperature controller 372 for introduction into reactor portion 302 via conduit 310.

Both the sodium chlorate and hydrochloric acid solutions can be heated to temperature of between 50° F. and 95° F. to promote reaction and the generation of a product stream consisting of chlorine dioxide, chlorine and steam, in gaseous form in the head space 303 of reactor portion 302, in accord with the invention. Utilizing an apparatus of FIG. 7 to practice the process of the invention provides a single reactor to achieve the benefits of the present invention.

As set forth in the co-pending application referred to above, the product stream consisting of chlorine dioxide, chlorine and steam can be utilized to provide effective treatment of drinking water. The product stream can be introduced directly into the water for treatment or can be subjected to separation and further reaction in accord with the methods set out in our co-pending application.

Various studies recommend a maximum chlorine dioxide partial pressure from 76 mm Hg to 150 mm Hg in order to avoid explosive conditions. Operation under a vacuum is an effective technique for maintaining chlorine dioxide below the explosive range. However, without other ways for reducing the partial pressure of chlorine a high level of vacuum is required for this approach alone to work. With vacuum alone, the intense vacuum requires energy intensive apparatus and expensive vacuum vessels. Use of this approach alone can result in explosion if the vacuum fails.

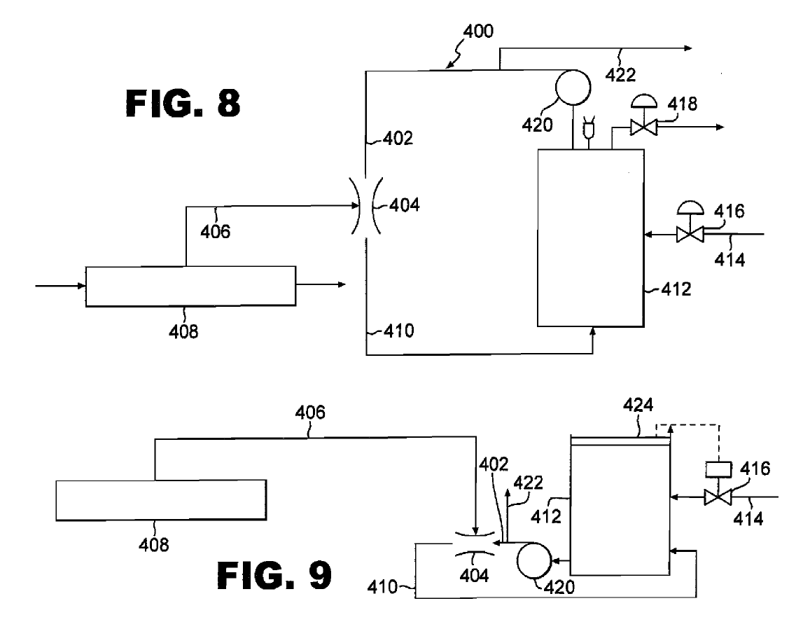

Another drawback to using vacuum to control the partial pressure of chlorine dioxide is that ejectors are commonly used to produce vacuum in chlorination systems and chlorine dioxide systems in water treatment. The volume of water required to operate an ejector at high vacuum is often such that the chlorine dioxide/chlorine solution is much more dilute than desired. If finished water is used to operate the ejector, the cost may be prohibitive. The high flow of water also sometimes causes high pressure drop in the lines used to convey the chlorine dioxide/chlorine solution from the generator to the point of application. This is often the case where a generator is installed in an existing water plant where it is difficult to install new lines to distribute the solution. In these cases, it may be desirable to increase the concentration of chlorine/chlorine dioxide in the solution. FIG. 8 shows a system for achieving this with minimal water consumption. In the system 400 of FIG. 8, water represented by arrow 402 is pumped through an ejector 404, creating a vacuum which pulls gas represented by arrow 406 from the reactor 408. The gas 406 dissolves in the water and the resulting solution represented by arrow 410 flows into a tank 412. It is important to avoid any gas head space in tank 412, since explosive levels of chlorine dioxide might accumulate. Therefore, makeup water 414 is supplied through a pressure regulated valve 416 to keep the tank full. Any gas bubbles that might accumulate are bled off through a gas vent valve 418 that is operated through an internal float valve (not shown). Solution represented by arrow 422 from the pressure side of pump 420 is conveyed to the application point.

A similar system is shown in FIG. 9 wherein the creation of a gas space is avoided by using a floating cover 424 on the tank.

Dilution of chlorine dioxide with chlorine is also effective in eliminating explosions. However, the ratio of chlorine to chlorine dioxide produced in pulp industry generators is far too low to eliminate explosions. In addition, traditionally, it is desirable to produce chlorine dioxide with minimal amounts of chlorine.

FIGS. 1, 6 and 7 show the outlet by means of which the gaseous products are removed from the reactor disposed immediately above the point at which reagents enter the reactor. This is advantageous since gas produced in the liquid inlet end of the reactor contains a greater concentration of chlorine dioxide than the gas produced further along the flowing stream of liquid reagents. By removing the gaseous products at that point, gas containing lower concentrations of chlorine dioxide and higher concentrations of chlorine is drawn countercurrent to the flow of liquid reagents and is used to dilute the more highly concentrated chlorine dioxide produced at the entrance point of the liquid reagents.

Dilution with steam is also an effective way to prevent explosions. However, the ratio of steam to chlorine dioxide needed to effectively control explosions can only be achieved through a combination of vacuum and elevated temperature. If vacuum is lost, and/or the temperature drops during process upset, a dangerous concentration of chlorine dioxide may occur.

Dilution with air is also effective for controlling explosions. However, in many cases the chlorine dioxide must be separated from the air in order for it to be useful in its application. In other cases handling large volumes of air is problematic in the application of chlorine dioxide.

In the pulp industry the normal practice is to accommodate occasional explosions by providing pressure relief devices such as blow-off lids and relief valves. The occurrence of noisy explosions and the resulting release of chlorine and chlorine dioxide that are accepted in the pulp industry would not be acceptable in the water treatment industry.

Table 4 shows the temperature and pressure increase that results from an explosion of chlorine/chlorine dioxide mixtures at different ratios. This is calculated from well known thermodynamic data. The minimum chlorine/chlorine dioxide ratio that can be produced by the acid/chlorate reaction without a reducing agent is 0.5:1 (or 57% ClO₂). Therefore the maximum pressure increase possible would be about 112 psi. The present invention is to prevent chlorine dioxide explosions by intentionally producing a higher level of Cl₂ than is typical in the pulp and paper industry, by diluting the chlorine dioxide with steam and chlorine produced in the reactor by operation under vacuum, and by immediately dissolving/condensing the chlorine/chlorine dioxide/steam mixture in flowing water.

TABLE 4

| | Cl₂ | O₂ | |
|---|---|---|---|
| Component | Temperature rise | Temperature rise | Pressure rise |
| Fraction ClO₂ | ° C. | ° F. | (psig) |
| 0.10 | 292.13 | 525.84 | 15.87 |
| 0.20 | 564.57 | 1016.23 | 32.10 |
| 0.30 | 819.24 | 1474.63 | 48.68 |
| 0.33 | 892.43 | 1606.37 | 53.71 |
| 0.40 | 1057.82 | 1904.07 | 65.56 |
| 0.50 | 1281.79 | 2307.21 | 82.71 |
| 0.60 | 1492.45 | 2686.40 | 100.12 |
| 0.67 | 1632.61 | 2938.71 | 112.44 |
| 0.70 | 1690.95 | 3043.72 | 117.75 |
| 0.80 | 1878.33 | 3380.99 | 135.60 |
| 0.90 | 2055.48 | 3699.86 | 153.64 |
| 1.00 | 2223.22 | 4001.80 | 171.85 |

Also, to assure safety, all components of the generator that might contain chlorine dioxide should be designed to contain the maximum pressure rise that could occur if vacuum and dilution failed. In practice, it would be advisable to design all components to accommodate a significantly higher pressure to allow for the effects of shock waves, provide for the remote possibility that pure chlorine dioxide could be produced, and provide a margin for safety. The horizontal pipe design proposed herein can readily accommodate this pressure rating, while the large diameter vessels used in pulp industry generators would have to be extremely expensive to achieve such a pressure rating.

Having thus described our invention with respect to several embodiments, what we desire to be secured by Letters Patent of the United States is set forth in the appended claims.

What is claimed:

1. A reactor for generating a gaseous mixture by reacting an aqueous solution of an alkali metal chlorate and an inorganic acid comprising:
a first horizontally disposed reactor section having a first end adapted to introduce said alkali metal chlorate and inorganic acid into said reactor section;
a second end of said reactor section having means to impound a volume of said aqueous solution of an alkali metal chlorate within said reactor with a gas space above said volume of said aqueous solution of an alkali metal chlorate;
means to introduce said inorganic acid at a plurality of locations along at least a portion of the length of said volume of said aqueous solution of an alkali metal chlorate;
means to withdraw gaseous reactant products from said gas space; and
collection means at said second end of said reactor section to collect waste liquor from said reactor section.

2. A reactor according to claim 1 wherein said means to introduce said inorganic acid is a diffuser disposed along the length of said volume of said aqueous solution of said alkali metal chlorate.

3. A reactor according to claim 1 wherein said reactor includes means to heat said aqueous solution of alkali metal chlorate and said inorganic acid before introduction into said reactor section.

4. A reactor according to claim 1 including means to maintain said reactor section at a constant temperature.

5. A reactor according to claim 1 wherein said reactor includes means to heat said aqueous solution of alkali metal chlorate and said inorganic acid as it flows from storage into said reactor section.

6. A reactor according to claim 1 wherein substantially all components of the reactor are designed to contain pressure of at least 180 psig.

7. A reactor according to claim 1 including means to use pressurized water to drive an ejector to create a vacuum to draw a mixture of chlorine dioxide, chlorine and steam into said water whereby said steam is condensed by said water and said chlorine dioxide and said chlorine are dissolved in said water.

8. A reactor according to claim 7 including an auxiliary tank connected to said reactor and said tank such that said water containing said dissolved chlorine dioxide and said chlorine are conducted to a tank wherein air separated from gaseous chlorine dioxide and chlorine can be safely vented and a solution of chlorine dioxide and chlorine dissolved in water can be withdrawn from said tank as a product stream.
